(19) United States
(12) Patent Application Publication
(10) Pub. No.: US 2016/0267861 A1
(43) Pub. Date: Sep. 15, 2016

(54) DEVICE AND METHOD FOR DRIVING LIQUID CRYSTAL DISPLAY PANEL

(71) Applicant: Synaptics Display Devices GK, Tokyo (JP)

(72) Inventor: Michihiro NAKAHARA, Nara (JP)

(21) Appl. No.: 15/061,498

(22) Filed: Mar. 4, 2016

(30) Foreign Application Priority Data
Mar. 13, 2015 (JP) 2015-051399

(51) Int. Cl. G09G 3/36

(52) U.S. Cl. CPC G09G 3/3607; G09G 3/3688; G09G 3/3696; G09G 2320/0646; G09G 2310/0286; G09G 2320/041

(57) ABSTRACT

A driver includes a temperature sensor, a drive circuitry configured to drive a source line of a liquid crystal display panel, and a precharge circuitry configured to perform a precharge operation of the source line. When a measured temperature by the temperature sensor is in a first temperature range, the precharge circuitry selectively performs the precharge operation of the source line in response to the grayscale level indicated by the image data. When the measured temperature is in a second temperature range lower than the first temperature range, the precharge circuitry performs a selected one of first and second operations. The first operation includes unconditionally performing the precharge operation of the source line independently of the grayscale level indicated by the image data, and the second operation includes unconditionally omitting the precharge operation of the source line independently of the grayscale level indicated by the image data.

### CROSS REFERENCE

This application claims priority of Japanese Patent Application No. 2015-051399, filed on Mar. 13, 2015, the disclosure which is incorporated herein by reference.

### TECHNICAL FIELD

The present invention relates to a liquid crystal display device, display driver and method for driving a liquid crystal display panel, more particularly, to control of drive operation for a liquid crystal display panel.

### BACKGROUND ART

The requirements specification of a liquid crystal display device, which displays images on a liquid crystal display panel, may include assurance of wide temperature range operation, especially in on-board use, for example. To assure wide temperature range operation, it is desired to keep image quality at low temperature.

On the other hand, reducing power consumed by a liquid crystal display device may be desired. Reducing power consumption is important especially when a liquid crystal display device is incorporated in a system which uses a power storage device (e.g. battery) as the power supply.

One known approach for reducing power consumption in a liquid crystal display device is controlling the precharge operation of a source line in response to the value of image data (data indicating the grayscale level of each pixel). In this technique, execution/non-execution of the precharge operation is selected, most typically, in response to the value of the most significant bit of image data. When a 256-level grayscale is displayed on each pixel, for example, the precharge operation is not performed for image data indicating a grayscale level of “127” or less (in this case, the most significant bit of the image data is “0”), and the precharge operation is performed for image data indicating a grayscale level of “128” or more (in this case, the most significant bit of the image data is “1”). A technique in which the precharge level is controlled on the grayscale level indicated by image data is also known in the art; such technique is disclosed in Japanese Patent Application Publication No. 2010-102146 A.

According to an inventor's study, however, the control of the source line precharge operation in response to the grayscale level indicated in image data may cause display quality deterioration of a liquid crystal display device at low temperature.

### SUMMARY OF INVENTION

One embodiment described herein is a driver adapted to drive a source line of a liquid crystal display panel. The driver includes a temperature sensor, a drive circuitry configured to drive the source line to a voltage corresponding to a grayscale level indicated by image data and a precharge circuitry configured to perform a precharge operation of the source line. When a measured temperature by the temperature sensor is in a first temperature range, the precharge circuitry selectively performs the precharge operation of the source line in response to the grayscale level indicated by the image data. When the measured temperature is in a second temperature range lower than the first temperature range, the precharge circuitry performs a selected one of first and second operations. The first operation includes unconditionally performing the precharge operation of the source line independently of the grayscale level indicated by the image data, and the second operation includes unconditionally omitting the precharge operation of the source line independently of the grayscale level indicated by the image data.

In another embodiment, a driver, which is adapted to drive a source line of a liquid crystal display panel, includes a temperature sensor, a drive circuitry configured to drive the source line in response to image data, a precharge circuitry configured to perform a precharge operation of the source line and an equalization circuitry configured to perform an equalization operation in which the source line is electrically connected to another source line of the liquid crystal display panel. When the measured temperature is in a first temperature range, the equalization circuitry performs the equalization operation in a first period of each horizontal sync period, the precharge circuitry performs the precharge operation of the source line in response to the grayscale level indicated by the image data in a second period of each horizontal sync period, the second period following the first period, and the drive circuitry drives the source line to the voltage corresponding to the grayscale level indicated by the image data in a third period of each horizontal sync period, the third period following the second period. When the measured temperature is in a second temperature range lower than the first temperature range, the equalization circuitry performs the equalization operation in the first period of each horizontal sync period, one of first and second operations selected in response to the grayscale level indicated by the image data is performed in the second period of each horizontal sync period, and the drive circuitry drives the source line to the voltage corresponding to the grayscale level indicated by the image data in the third period of each horizontal sync period. In the first operation, the precharge circuitry performs the precharge operation of the source line. In the second operation, the drive circuitry drives the source line to the voltage corresponding to the grayscale level indicated by the image data.

The drivers thus structured may be used in a liquid crystal display device.

Provided in still another embodiment is a method for driving a liquid crystal display panel of a liquid crystal display device including a temperature sensor. The method includes: performing a precharge operation of a source line of the liquid crystal display panel in response to a measured temperature by the temperature sensor; and driving the source line to a voltage corresponding to a grayscale level indicated by image data. The step of performing the precharge operation includes: performing the precharge operation of the source line in response to the grayscale level indicated by the image data when the measured temperature is in a first temperature range; and performing a selected one of first and second operations when the measured temperature is in a second temperature range lower than the first temperature range. The first operation includes unconditionally performing the precharge operation of the source line independently of the grayscale level indicated by the image data, and the second operation includes unconditionally omitting the precharge operation of the source line independently of the grayscale level indicated by the image data.

Provided in still another embodiment is another method for driving a liquid crystal display panel of a liquid crystal display device including a temperature sensor. This method includes: performing an equalization operation in which the source line is electrically connected to another source line of the liquid crystal display panel, in a first period of each horizontal sync period; selectively performing one of first and second operations in response to a measured temperature by the temperature sensor in a second period of each horizontal sync period, the second period following the first period; and driving the source line to the voltage corresponding to the grayscale level indicated by the image data in a third period of each horizontal sync period, third period following the second period. The first operation includes performing a precharge operation of the source line by the precharge circuitry in response to the grayscale level indicated by the image data, and the second operation includes driving the source line to the voltage corresponding to the grayscale level indicated by the image data by the drive circuitry. When the measured temperature is in a first temperature range, the precharge operation of the source line is performed in response to the grayscale level indicated by the image data when the measured temperature in the second period of each horizontal sync period. When the measured temperature is in a second temperature range lower than the first temperature range, one of the first and second operations selected in response to the grayscale level indicated by the image data is performed in the second period of each horizontal sync period.

The present invention effectively suppresses display quality deterioration of a liquid crystal display device at low temperature.

### BRIEF DESCRIPTION OF THE DRAWINGS

FIG. 1 is a timing chart illustrating one example of a drive operation of a source line in a certain horizontal sync period in the case that execution/non-execution of the precharge operation is selected in response to the value of the most significant bit of image data;

FIG. 2 illustrates an example of an actually-perceived image in the case that an image in which the grayscale levels incrementally vary from 0 to 255 in the left-to-right direction is displayed on a liquid crystal display panel;

FIG. 3 is a block diagram illustrating an exemplary configuration of a liquid crystal display device in one embodiment of the present invention;

FIG. 4 is a circuit diagram illustrating one example of the configuration of a source driver circuit in the present embodiment;

FIG. 5A is a conceptual diagram illustrating one example of the drive operation of a liquid crystal display panel in the present embodiment;

FIG. 5B is a conceptual diagram illustrating another example of the drive operation of a liquid crystal display panel in the present embodiment;

FIGS. 6A and 6B are timing charts illustrating a source line drive operation in embodiment #1;

FIGS. 7A and 7B are timing charts illustrating a source line drive operation in embodiment #2;

FIGS. 8A and 8B are timing charts illustrating a source line drive operation in embodiment #3; and

FIGS. 9A and 9B are timing charts illustrating a source line drive operation in embodiment #4.

### DESCRIPTION OF PREFERRED EMBODIMENTS

The invention will be now described herein with reference to illustrative embodiments. Those skilled in the art would recognize that many alternative embodiments can be accomplished using the teachings of the present invention and that the invention is not limited to the embodiments illustrated for explanatory purposed.

For easy understanding of a technical concept embodied in the embodiments described below, a description is first given of a problem that may occur in the case when a control of the source line precharge operation is implemented in response to the grayscale level indicated in image data when driving a liquid crystal display panel.

One objective of the present disclosure is to suppress display quality deterioration of a liquid crystal display device at low temperature. Other objectives and new features of the present disclosure would be understood by a person skilled in the art from the following disclosure.

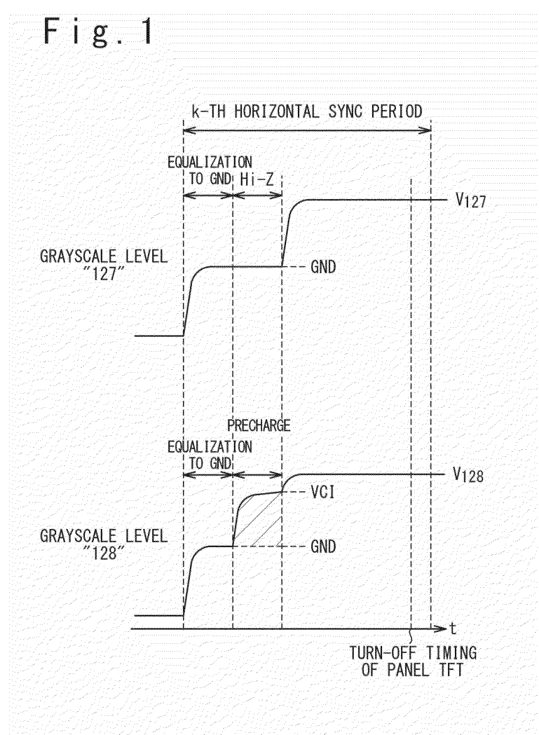

FIG. 1 is a timing chart illustrating one example of the source line drive operation in a certain horizontal sync period (hereinafter, referred to as k-th horizontal sync period) in the case that a control of the source line precharge operation is implemented in response to the grayscale level indicated in image data, more specifically, in the case that execution/non-execution of the precharge operation is selected in response to the value of the most significant bit of image data. Note that FIG. 1 illustrates the operation in the case that a source line that has been driven to a negative voltage in the immediately previous horizontal sync period (the (k−1)-th horizontal sync period) is driven to a positive voltage in the k-th horizontal sync period, and a 256-level grayscale is displayed on each pixel. In this case, image data associated with each pixel is 8-bit data and the most significant bit (MSB) of the image data is set to “0” for a grayscale level of 0 to 127 and “1” for a grayscale level of 128 to 255.

In the drive operation illustrated in FIG. 1, the precharge operation is not performed when the most significant bit of the image data is “0”, whereas the precharge operation is performed when the most significant bit of the image data is “1”. For example, the upper section of FIG. 1 illustrates the voltage waveform of the source line in the case that the grayscale level of a corresponding pixel is “127” in the k-th horizontal sync period, and the lower section illustrates the voltage waveform of the source line in the case that the grayscale level of the pixel is “128” in the k-th horizontal sync period.

For the drive operation in each horizontal sync period, three periods are defined: an equalization period, a precharge period and a drive period. The precharge period is defined to follow the equalization period and the drive period is defined to follow the precharge period. In the equalization period, the source lines are equalized. In one example, the source lines of the liquid crystal display panel are electrically connected to one another and set to the same potential level (for example, the circuit ground level). FIG. 1 illustrates the voltage waveform of a source line in the case that the source line is set to the circuit ground level GND in the source line equalization.

In the precharge period, which follows the equalization period, a precharge operation is performed in response to the most significant bit of image data. More specifically, the source line is precharged in the precharge period when the most significant bit of the image data is “1”. In FIG. 1, the voltage waveform of the source line is illustrated with an assumption that the source line is precharged to a voltage VCI. The precharge operation is not performed in the precharge period, when the most significant bit of the image data is “0”. In this case, the source line is set to high impedance (Hi-Z). The voltage on the source line basically remains unchanged when the source line is set to high impedance. Such operation allows selectively performing the precharge operation only when the source line is to be driven to a high voltage, and this effectively reduces the power consumption.

In the drive period, which follows the precharge period, the source line is driven to the voltage corresponding to the grayscale level. In FIG. 1, the voltage corresponding to a grayscale level of “127” is denoted by the legend “V₁₂₇” and the voltage corresponding to a grayscale level of “128” is denoted by the legend “V₁₂₈”. Driving the source line with an output circuit having a sufficiently-large drive capacity enables driving the source line to the voltage corresponding to the grayscale level at a time sufficiently earlier than the turn-off timing of the TFT (thin film transistor) of the relevant pixel.

In the drive method illustrated in FIG. 1, the actually-perceived brightness of a pixel (the brightness of a pixel in an image actually displayed on the liquid crystal display panel) is determined by the voltage to which the associated source line is finally driven (V₁₂₇ or V₁₂₈ in the operation illustrated in FIG. 1) regardless of execution/non-execution of the precharge operation, when the liquid crystal has a sufficiently fast response speed. Accordingly, the pixel is driven so that there is a slight brightness difference corresponding to the difference of “1” in the grayscale level, between the case for the grayscale level of “127” and the case for the grayscale level of “128”.

When the liquid crystal display device is operated at such a low temperature that the response speed of the liquid crystal is reduced, in contrast, the actually-perceived brightness of the pixel depends on the effective voltage on the associated source line (the time average of the voltage on the source line). As a result, the actually-perceived brightness of the pixel largely varies at the grayscale level at which the execution/non-execution of the precharge operation is switched. In the example illustrated in FIG. 1, for example, a large difference occurs in the actually-perceived brightness of the pixel between the cases for the grayscale levels of “127” and “128”, when the liquid crystal display device is operated at a low temperature.

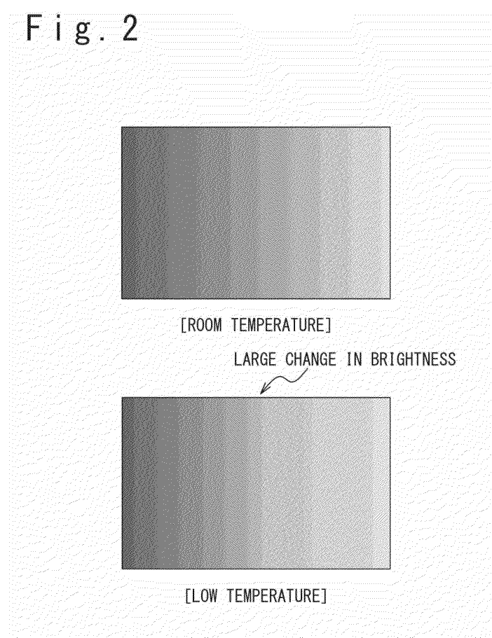

For example, FIG. 2 illustrates an example of an actually-perceived image in the case that an image in which the grayscale levels incrementally vary from 0 to 255 in the left-to-right direction is displayed on a liquid crystal display panel. When the liquid crystal display device is operated at a room temperature, an image in which the brightness smoothly varies in the left-to-right direction is displayed on the liquid crystal display device. When the liquid crystal display device is operated at a low temperature, in contrast, a large brightness difference is observed between the position at which the grayscale level is “127” and the position at which the grayscale level is “128” in the image actually displayed on the liquid crystal display panel.

This effect undesirably deteriorates the image quality when the liquid crystal display device is operated at a low temperature. In the embodiments described in the following, an approach is used which reduces the deterioration of the image quality of a liquid crystal display device at a low temperature.

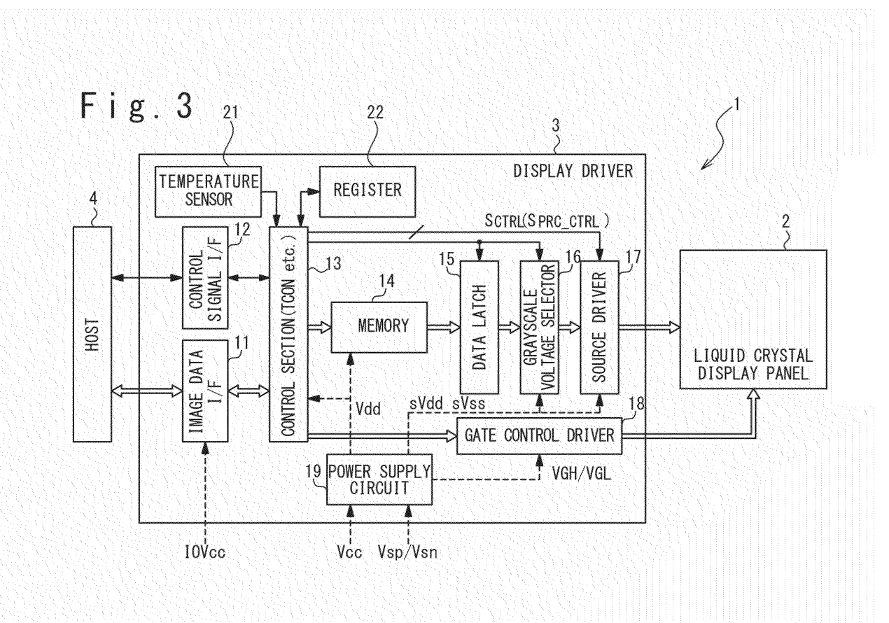

FIG. 3 is a block diagram illustrating an exemplary configuration of a liquid crystal display device 1 in one embodiment. The liquid crystal display device 1 includes a liquid crystal display panel 2 and a display driver 3. The liquid crystal display panel 2 includes a plurality of pixels arrayed in rows and columns, a plurality of gate lines and a plurality of source lines (note that the pixels, gate lines and source lines are not illustrated in FIG. 3). Each pixel is connected to an associated gate line and source line. The display driver 3 drives the liquid crystal display panel 2 in response to image data and control signals received from the host 4.

The display driver 3 includes: an image data interface 11, a control signal interface 12, a control section 13, a memory 14, a data latch 15, a grayscale voltage selector circuit 16, a source driver circuit 17, a gate control driver 18, a power supply circuit 19, a temperature sensor 21 and a register 22.

The image data interface 11 transfers the image data received from the host 4 to the control section 13 and the control signal interface 12 feeds to the control section 13 various control data (e.g. control commands and control parameters) generated from the control signals received from the host 4.

The control section 13 controls respective circuits integrated in the display driver 3 in response to the control data received from the control signal interface 12. In detail, the control section 13 includes a timing controller to achieve timing control of the respective circuits integrated in the display driver 3. As described later, the control section 13 also has the function of controlling the operation of the source driver circuit 17, especially the precharge operation of the source lines; the control section 13 generates a series of source driver control signals S_{CTRL} which are used to control the operation of the source driver circuit 17. The series of source driver control signals S_{CTRL} include a precharge control signal S_{PRE}_{_}_{CTRL}, which controls the precharge operation. The control section 13 further has the function of transferring the image data received from the image data interface 11, to the memory 14.

The memory 14, the data latch 15, the grayscale voltage selector circuit 16 and the source driver circuit 17 form a drive circuitry which drives the respective source lines of the liquid crystal display panel 2 in response to the image data received from the control section 13. In detail, the memory 14 temporarily stores therein the image data received from the control section 13. In one embodiment, the memory 14 is configured to store image data for one frame image. The data latch 15 latches the image data received from the memory 14 and transfers the latched image data to the grayscale voltage selector circuit 16. In one embodiment, the data latch 15 is configured to latch image data corresponding to pixels of one horizontal line of the liquid crystal display panel 2 (that is, pixels connected to one gate line) at the same time. The grayscale voltage selector circuit 16 selects grayscale voltages corresponding to the image data received from the data latch 15 and feeds the selected grayscale voltages to the source driver circuit 17. The source driver circuit 17 receives the grayscale voltages associated with the respective source lines of the liquid crystal display panel 2 from the grayscale voltage selector circuit 16. The source driver circuit 17 drivers the respective source lines of the liquid crystal display panel 2 to the voltages corresponding to the grayscale voltages received from the grayscale voltage selector circuit 16.

The gate control driver 18 drives the gate lines of the liquid crystal display panel 2. Alternatively, in the case that the liquid crystal display panel 2 integrates therein a gate driver circuit that drives the gate lines (such a gate driver circuit is often referred to as a GIP (gate-in-panel) circuit), the gate control driver 18 may feed to the liquid crystal display panel 2 a set of control signals which control the gate driver circuit.

The power supply circuit 19 generates various power supply voltages used for the operations of the respective circuits integrated in the display driver 3, from a power supply voltage Vcc and a pair of analog power supply voltages Vsp and Vsn, which are externally fed to the power supply circuit 19. In one embodiment, the power supply circuit 19 feeds to the control section 13 and the memory 14 a logic power supply voltage Vdd generated from the power supply voltage Vcc. The power supply circuit 19 also feeds to the grayscale voltage selector circuit 16 and the source driver circuit 17 a pair of analog power supply voltages sVdd and sVss which are generated from the analog power supply voltages Vsp and Vsn, and further feeds to the gate control driver 18 a gate high voltage VGH and gate low voltage VGL which are generated from the analog power supply voltages Vsp and Vsn.

The temperature sensor 21 and the register 22 feeds to the control section 13 information used for the precharge operation control performed by the control section 13. In detail, the temperature sensor 21 functions as a temperature measurement means configured to generate temperature data corresponding to the temperature of the temperature sensor 21 and feed the temperature data to the control section 13. The temperature sensor 21 may include a semiconductor circuit having temperature-dependent characteristics. Since the temperature sensor 21 has a temperature close to the atmosphere temperature of the liquid crystal display device 1 or the temperature of the liquid crystal display panel 2, the temperature data generated by the temperature sensor 21 indicates a value corresponding to the atmosphere temperature of the liquid crystal display device 1 or the temperature of the liquid crystal display panel 2.

The register 22 stores therein precharge control data used for the precharge operation control performed by the control section 13. The precharge control data specify a precharge operation to be performed in each temperature range. The contents of the precharge control data and the precharge operation control based on the precharge control data are described later in detail. The register 22 may be used also for storing control parameters other than the precharge control data.

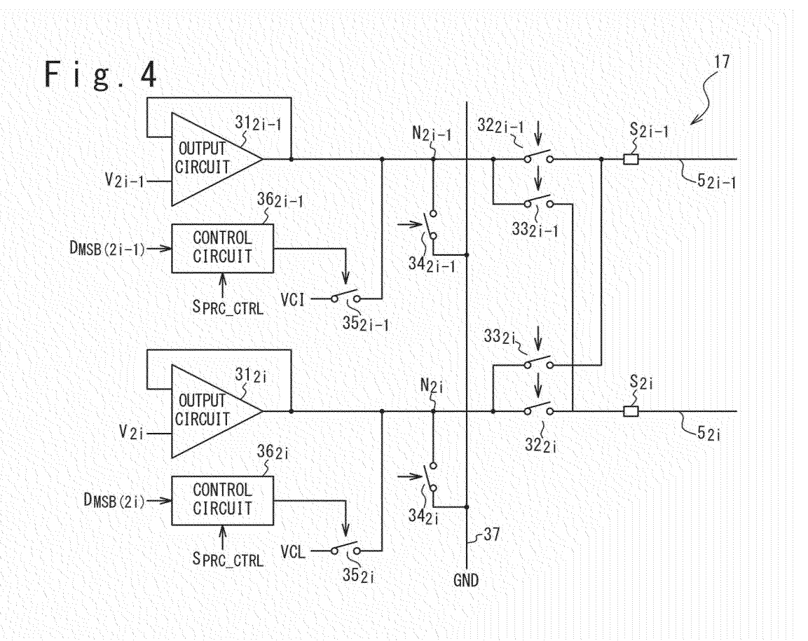

FIG. 4 is a circuit diagram illustrating one example of the configuration of the source driver circuit 17, more specifically, the configuration of a drive section that drives an odd-numbered source output S₂ᵢ₋₁ and an even-numbered source output S₂ᵢ adjacent thereto, in the source driver circuit 17. The source outputs S₂ᵢ₋₁ and S₂ᵢ are connected to source lines 5₂ᵢ₋₁ and 5₂ᵢ of the liquid crystal display panel 2, respectively. This implies that the drive section drives the source lines 5₂ᵢ₋₁ and 5₂ᵢ via the source outputs S₂ᵢ₋₁ and S₂ᵢ.

The drive section of the source driver circuit 17 illustrated in FIG. 4 is configured to drive two pixels adjacent in the horizontal direction (the direction in which the gate lines are extended) with voltages of opposite polarities. In other words, the drive section of the source driver circuit 17 drives one of the source outputs S₂ᵢ₋₁ and S₂ᵢ to a positive voltage and the other to a negative voltage. This configuration is especially preferable for achieving a dot inversion drive. In the following, a detailed description is given of the configuration of the source driver circuit 17 illustrated in FIG. 4.

The source driver circuit 17 includes: output circuits 31₂ᵢ₋₁, 31₂ᵢ, straight switches 32₂ᵢ₋₁, 32₂ᵢ, cross switches 33₂ᵢ₋₁, 33₂ᵢ, equalizing switches 34₂ᵢ₋₁, 34₂ᵢ, precharge switches 35₂ᵢ₋₁, 35₂ᵢ and control circuits 36₂ᵢ₋₁ and 36₂ᵢ.

The output circuit 31₂ᵢ₋₁ outputs a voltage corresponding to the grayscale voltage V₂ᵢ₋₁ received from the grayscale voltage selector circuit 16 (most typically, the same voltage as the grayscale voltage V₂ᵢ₋₁), and the output circuit 31₂ᵢ outputs a voltage corresponding to the grayscale voltage V₂ᵢ received from the grayscale voltage selector circuit 16 (most typically, the same voltage as the grayscale voltage V₂ᵢ). The output of the output circuit 31₂ᵢ₋₁ is connected to a node N₂ᵢ₋₁ and the output of the output circuit 31₂ᵢ is connected to a node N₂ᵢ.

The output circuit 31₂ᵢ₋₁ is configured to output a positive voltage and the output circuit 31₂ᵢ is configured to output a negative voltage. Note that the grayscale voltage selector circuit 16 selects the grayscale voltages V₂ᵢ₋₁ and V₂ᵢ so that the grayscale voltage V₂ᵢ₋₁ corresponds to a positive voltage to which one of the source lines 5₂ᵢ₋₁ and 5₂ᵢ, which are connected to the source outputs S₂ᵢ₋₁ and S₂ᵢ, is to be driven, and the grayscale voltage V₂ᵢ corresponds to a negative voltage to which the other of the source lines 5₂ᵢ₋₁ and 5₂ᵢ is to be driven.

The straight switches 32₂ᵢ₋₁, 32₂ᵢ and the cross switches 33₂ᵢ₋₁ and 33₂ᵢ form a switch circuitry configured to switch connections among the nodes N₂ᵢ₋₁, N₂ᵢ and the source outputs S₂ᵢ₋₁ and S₂ᵢ. In detail, the straight switches 32₂ᵢ₋₁ is connected between the node N₂ᵢ₋₁ and the source output S₂ᵢ₋₁ and the straight switches 32₂ᵢ is connected between the node N₂ᵢ and the source output S₂ᵢ. The straight switches 32₂ᵢ₋₁ and 32₂ᵢ are turned on when the source line 5₂ᵢ₋₁ (and the source output S₂ᵢ₋₁ connected thereto) is to be driven to a positive voltage and the source line 5₂ᵢ (and the source output S₂ᵢ connected thereto) is to be driven to a negative voltage.

Meanwhile, the cross switch 33₂ᵢ₋₁ is connected between the node N₂ᵢ₋₁ and the source output S₂ᵢ and the cross switch 33₂ᵢ is connected between the node N₂ᵢ and the source output S₂ᵢ₋₁. The cross switches 33₂ᵢ₋₁ and 33₂ᵢ are turned on when the source line 5₂ᵢ₋₁ (and the source output S₂ᵢ₋₁ connected thereto) is to be driven to a negative voltage and the source line 5₂ᵢ (and the source output S₂ᵢ connected thereto) is to be driven to a positive voltage.

The equalizing switch 34₂ᵢ₋₁ is connected between the node N₂ᵢ₋₁ and a circuit ground line 37 and the equalizing switch 34₂ᵢ is connected between the node N₂ᵢ and the circuit ground line 37. The equalizing switches 34₂ᵢ₋₁ and 34₂ᵢ, which form an equalization circuitry which performs equalization of the source lines 5₂ᵢ₋₁ and 5₂ᵢ, are turned on when the equalization of the source lines 5₂ᵢ₋₁ and 5₂ᵢ are performed. It should be noted that, in the present embodiment, the straight switches 32₂ᵢ₋₁, 32₂ᵢ and/or the cross switches 33₂ᵢ₋₁ and 33₂ᵢ are also turned on when the equalization of the source lines 5₂ᵢ₋₁ and 5₂ᵢ are performed.

The precharge switches 35₂ᵢ₋₁, 35₂ᵢ and the control circuits 36₂ᵢ₋₁ and 36₂ᵢ form a precharge circuitry which precharges the source lines 5₂ᵢ₋₁ and 5₂ᵢ.

In detail, the precharge switch 35₂ᵢ₋₁ is connected between the node N₂ᵢ₋₁ and a node fed with a voltage VCI, and the precharge switch 35₂ᵢ is connected between the node N₂ᵢ and a node fed with a voltage VCL, where the voltage VCI is a predetermined positive voltage and the voltage VCL is a predetermined negative voltage. The precharge switch 35₂ᵢ₋₁ is turned on when one of the source lines 5₂ᵢ₋₁ and 5₂ᵢ which is to be driven to a positive voltage is precharged to the voltage VCI, and the precharge switch 35₂ᵢ is turned on when the other of the source lines 5₂ᵢ₋₁ and 5₂ᵢ, which is to be driven to a negative voltage, is precharged to the voltage VCL.

The control circuit 36₂ᵢ₋₁ controls the precharge switch 35₂ᵢ₋₁ and the control circuit 36₂ᵢ controls the precharge switch 35₂ᵢ. In the present embodiment, the control circuit 36₂ᵢ₋₁ controls the precharge switch 35₂ᵢ₋₁ in response to the precharge control signal S_{PRC}_{_}_{CTRL} received from the control section 13 and the most significant bit D_{MSB(2i-1)} of the image data D₂ᵢ₋₁ corresponding to the grayscale voltage V₂ᵢ₋₁. Similarly, the control circuit 36₂ᵢ controls the precharge switch 35₂ᵢ in response to the precharge control signal S_{PRC}_{_}_{CTRL} received from the control section 13 and the most significant bit D_{MSB(2i)} of the image data D₂ᵢ corresponding to the grayscale voltage V₂ᵢ. In the present embodiment, as described later in detail, the precharge control signal S_{PRC}_{_}_{CTRL} is generated in response to the temperature data generated by the temperature sensor 21, and thereby the execution/non-execution of the precharge operation is controlled in response to the temperature measured by the temperature sensor 21 (which may be simply referred to as the measured temperature, hereinafter).

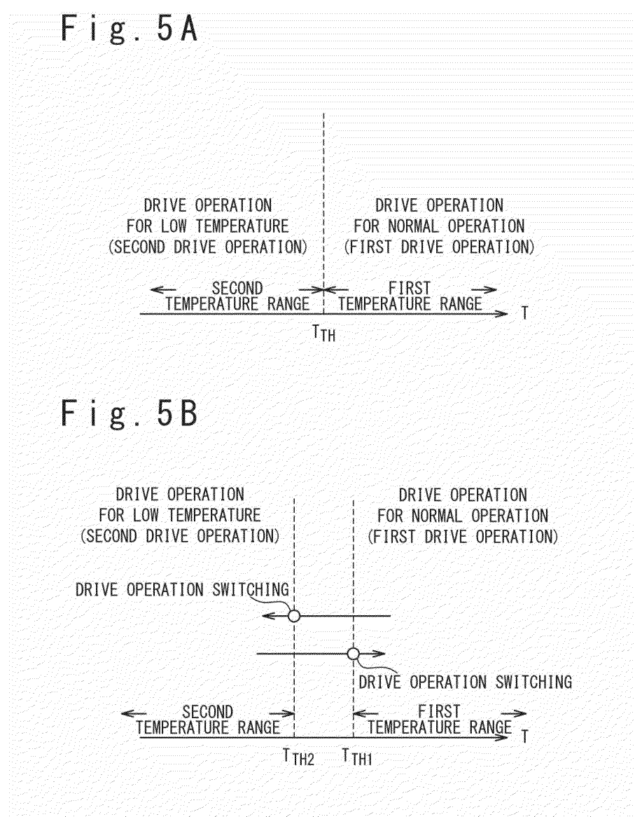

FIG. 5A is a conceptual diagram illustrating one example of the drive operation of the liquid crystal display panel 2 in the present embodiment. In the present embodiment, a drive operation different from the normal operation is performed when the liquid crystal display device 1 is operated at low temperature. More specifically, a normal drive operation (a first drive operation) is performed when the measured temperature by the temperature sensor 21 is in a first temperature range which is higher than a predetermined threshold temperature T_{TH}, and a low temperature drive operation (a second drive operation) is performed when the measured temperature by the temperature sensor 21 is in a second temperature range which is lower than a predetermined threshold temperature T_{TH}. The threshold temperature T_{TH} may be specified in the precharge control data set to the register 22.

In the normal drive operation, the source line precharge operation is controlled in response to the grayscale levels indicated by the image data. More particularly, Execution/non-execution of the precharge operation is selected in response to the most significant bit of the image data in the normal drive operation. This operation effectively reduces the power consumption.

In the low temperature drive operation, in contrast, the precharge operation of the source lines is controlled independently of the grayscale levels indicated by the image data. In one embodiment, the precharge operation may be omitted in the low temperature drive operation, independently of the grayscale levels indicated by the image data (that is, independently of the most significant bits of the image data). In an alternative embodiment, the precharge operation may be unconditionally performed in the low temperature drive operation, independently of the grayscale levels indicated by the image data (that is, independently of the most significant bits of the image data). When the precharge operation of the source lines is controlled independently of the grayscale levels indicated by the image data, this effectively resolves the problem that the actually-perceived brightness of a pixel largely varies at the grayscale level at which execution/non-execution of the precharge operation is switched. For example, when the precharge operation is omitted independently of the grayscale levels indicated by the image data in the low temperature drive operation, this effectively resolves the problem that the actually-perceived brightness of a pixel largely varies at the grayscale level at which execution/non-execution of the precharge operation is switched.

The low temperature drive operation may be switched among a plurality of drive operations by modifying the precharge control data set in the register 22. For example, the low temperature drive operation may be modified by writing precharge control data specifying a desired drive operation into the register 22 from the host 4.

When the drive operation is switched in response to whether or not the measured temperature by the temperature sensor 21 is higher than the predetermined threshold temperature T_{TH}, as illustrated in FIG. 5A, the switching between the normal drive operation and the low temperature drive operation may occur frequently, when the measured temperature by the temperature sensor 21 is close to the threshold temperature T_{TH}. To avoid this problem, the drive operation may be switched with a hysteresis behavior.

FIG. 5B is a conceptual diagram illustrating the drive operation of the liquid crystal display panel 2 in the case that the drive operation is switched with a hysteresis behavior. More particularly, when the measured temperature by the temperature sensor 21 is higher than a first threshold temperature T_{TH1}, the normal drive operation is performed. In the normal drive operation, as described above, the source line precharge operation is controlled in response to the grayscale levels indicated by the image data. More specifically, execution/non-execution of the precharge operation is selected in response to the most significant bit of the image data in the normal drive operation.

When the temperature measured by the temperature sensor 21 becomes lower than a second threshold temperature T_{TH2} which is lower than the first threshold temperature T_{TH1} in the normal drive operation, the drive operation of the liquid crystal display panel 2 is switched to the low temperature drive operation. As described above, the precharge operation of the source lines is controlled independently of the grayscale levels indicated by the image data in the low temperature drive operation. When the temperature measured by the temperature sensor 21 becomes higher than the first threshold temperature T_{TH1} in the low temperature drive operation, on the other hand, the drive operation of the liquid crystal display panel 2 is switched to the normal drive operation. The first and second threshold temperatures T_{TH1} and T_{TH2} may be specified in the precharge control data set to the register 22.

In this operation, the normal drive operation is performed when the measured temperature by the temperature sensor 21 is in a first temperature range higher than the first threshold temperature T_{TH1}, and the low temperature drive operation is performed when the measured temperature by the temperature sensor 21 is in a second temperature range lower than the second threshold temperature T_{TH2}. When the measured temperature by the temperature sensor 21 is in the range between the first and second threshold temperatures T_{TH1} and T_{TH2}, a selected one of the normal drive operation and the low temperature drive operation is performed depending on the changes in the measured temperature by the temperature sensor 21 in the past.

It should be noted that the normal drive operation is performed in the first temperature range and the low temperature drive operation is performed in the second temperature range, which is lower than the first temperature range, in both of the drive operations illustrated in FIGS. 5A and 5B.

As described above, in the present embodiment, the precharge operation of the source lines is controlled independently of the grayscale levels indicated by the image data in the low temperature drive operation; it should be noted however that the low temperature drive operation may be variously modified. In the following, a description is given of various embodiments of the drive method of the liquid crystal display panel, more particularly, various examples of the low temperature drive operation. In the examples described in the following, it is assumed that 256-level grayscale is displayed on each pixel. In this case, image data associated with each pixel are 8-bit data; the most significant bit of image data is set to “0” when the grayscale level indicated by the image data is 0 to 127, and set to “1” when the grayscale level indicated by the image data is 128 to 255.

### Embodiment #1

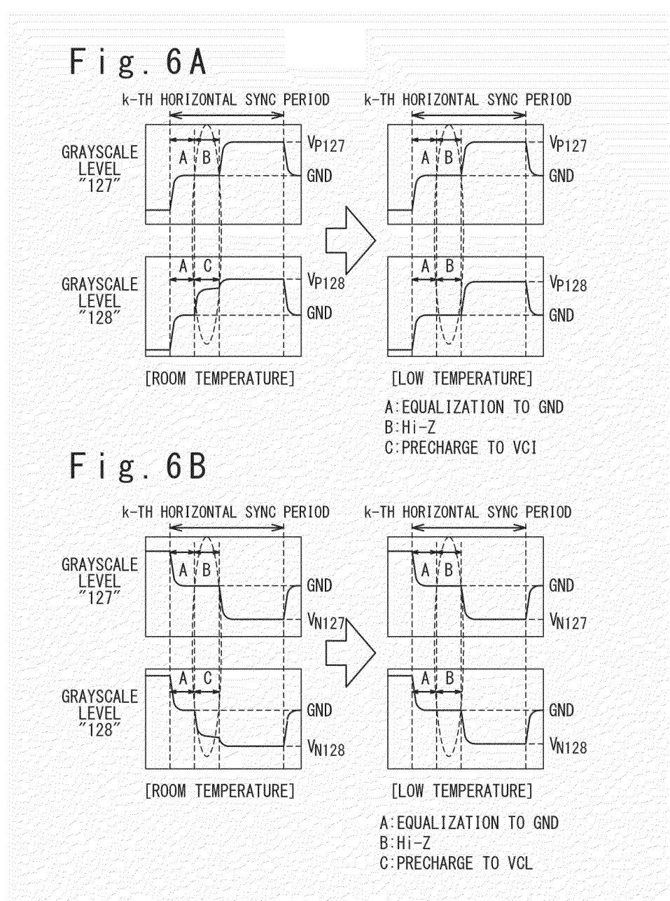

FIGS. 6A and 6B are timing charts illustrating one example of the drive operation of the source lines in the k-th horizontal sync period in embodiment #1. Note that FIG. 6A illustrates an exemplary operation in the case that a source line which has been driven to a negative voltage in the immediately previous horizontal sync period ((k−1)-th horizontal sync period) is driven to a positive voltage in the k-th horizontal sync period, and FIG. 6B illustrates an exemplary operation in the case that a source line which has been driven to a positive voltage in the immediately previous horizontal sync period ((k−1)-th horizontal sync period) is driven to a negative voltage in the k-th horizontal sync period. With respect to the source driver circuit 17 illustrated in FIG. 4, for example, the voltage waveforms on the source lines 5₂ᵢ₋₁ and 5₂ᵢ are illustrated in FIGS. 6A and 6B, respectively, for the case that the source lines 5₂ᵢ₋₁ and 5₂ᵢ are driven to positive and negative drive voltages in the k-th horizontal sync period, respectively. For the case that the source lines 5₂ᵢ₋₁ and 5₂ᵢ are driven to negative and positive drive voltages in the k-th horizontal sync period, respectively, on the other hand, the voltage waveforms on the source lines 5₂ᵢ₋₁ and 5₂ᵢ are illustrated in FIGS. 6B and 6A, respectively.

When a room temperature is measured by the temperature sensor 21, the normal drive operation is performed. More specifically, in the drive operation illustrated in FIG. 5A, for example, the normal drive operation is performed when the measured temperature by the temperature sensor 21 is higher than the threshold temperature T_{TH}. In the drive operation illustrated in FIG. 5B, on the other hand, the normal drive operation is performed when the liquid crystal display device 1 is switched from the state in which the measured temperature by the temperature sensor 21 is lower than the first threshold temperature T_{TH1} to the state in which the measured temperature by the temperature sensor 21 is higher than the first threshold temperature T_{TH1}, or when the measured temperature by the temperature sensor 21 is continuously kept higher than the first threshold temperature T_{TH1}.

When a low temperature is measured by the temperature sensor 21, the low temperature drive operation is performed. More specifically, in the drive operation illustrated in FIG. 5A, for example, the low temperature drive operation is performed when the measured temperature by the temperature sensor 21 is lower than the threshold temperature T_{TH}. In the drive operation illustrated in FIG. 5B, on the other hand, the low temperature drive operation is performed when the liquid crystal display device 1 is switched from the state in which the measured temperature by the temperature sensor 21 is higher than the second threshold temperature T_{TH2} to the state in which the measured temperature by the temperature sensor 21 is lower than the second threshold temperature T_{TH2}, or when the measured temperature by the temperature sensor 21 is continuously kept lower than the second threshold temperature T_{TH2}. In the following, a description is given of exemplary operations of the liquid crystal display device 1 in the normal drive operation and the low temperature drive operation, respectively.

### (1) Normal Drive Operation

The left columns of FIGS. 6A and 6B are timing charts illustrating the operation of the liquid crystal display device 1 in the k-th horizontal sync period in embodiment #1 in the case that the normal drive operation is performed.

When the source line 5₂ᵢ₋₁ is driven to a positive drive voltage and the source line 5₂ᵢ is driven to a negative drive voltage in the k-th horizontal sync period, the straight switches 32₂ᵢ₋₁ and 32₂ᵢ are turned on to electrically connect the source lines 5₂ᵢ₋₁ and 5₂ᵢ to the nodes N₂ᵢ₋₁ and N₂ᵢ, respectively, in the k-th horizontal sync period. When the source line 5₂ᵢ₋₁ is driven to a negative drive voltage and the source line 5₂ᵢ is driven to a positive drive voltage in the k-th horizontal sync period, on the other hand, the cross switches 33₂ᵢ₋₁ and 33₂ᵢ are turned on to electrically connect the source lines 5₂ᵢ₋₁ and 5₂ᵢ to the nodes N₂ᵢ and N₂ᵢ₋₁, respectively, in the k-th horizontal sync period.

When the normal drive operation is performed, the precharge control signal S_{PRC}_{_}_{CTRL} is asserted by the control section 13 in the source driver circuit 17 illustrated in FIG. 4. When the precharge control signal S_{PRC}_{_}_{CTRL} is asserted, the control circuit 36₂ᵢ₋₁ is placed into the state in which the control circuit 36₂ᵢ₋₁ controls the precharge switch 35₂ᵢ₋₁ in response to the most significant bit D_{MSB(2i-1)} of the image data D₂ᵢ₋₁, and the control circuit 36₂ᵢ is placed into the state in which the control circuit 36₂ᵢ controls the precharge switch 35₂ᵢ in response to the most significant bit D_{MSB(2i)} of the image data D₂ᵢ.

When the normal drive operation is performed in the k-th horizontal sync period, three periods are defined in the k-th horizontal sync period: an equalization period, a precharge period, and a drive period. The precharge period is defined to follow the equalization period and the drive period is defined to follow the precharge period.

In the equalization period, equalization of the source lines is performed. More specifically, the equalizing switches 34₂ᵢ₋₁ and 34₂ᵢ are turned on to connect the nodes N₂ᵢ₋₁ and N₂ᵢ to the circuit ground line 37, and the outputs of the output circuits 31₂ᵢ₋₁ and 31₂ᵢ are placed into the high impedance (Hi-Z) state. This results in that the source lines 5₂ᵢ₋₁ and 5₂ᵢ are electrically connected to the circuit ground line 37, and thereby equalized to the circuit ground level. FIGS. 6A and 6B illustrate the voltage waveforms of the source lines when the source lines are set to the circuit ground level GND. In FIGS. 6A and 6B, the legends “A” denote the operation in which the source lines are equalized to the circuit ground level GND.

In the precharge period, which follows the equalization period, the precharge operation is performed in response to the grayscale levels indicated by the image data, more particularly, to the most significant bit of the image data associated with each pixel. More specifically, the operation descried below is performed in the precharge period.

The control circuit 36₂ᵢ₋₁ turns off the precharge switch 35₂ᵢ₋₁ when the most significant bit of the image data D₂ᵢ₋₁ is “0” and turns on the precharge switch 35₂ᵢ₋₁ when the most significant bit of the image data D₂ᵢ₋₁ is “1”. This results in that, as illustrated in FIG. 6A, the source line to be driven to a positive drive voltage selected from the source lines 5₂ᵢ₋₁ and 5₂ᵢ is placed into the high impedance state when the most significant bit of the image data D₂ᵢ₋₁ is “0” and precharged to the voltage VCI when the most significant bit of the image data D₂ᵢ₋₁ is “1.”

The upper left section of FIG. 6A illustrates the voltage waveform of the source line driven to a positive drive voltage in the k-th horizontal sync period for the case when the grayscale level of the image data D₂ᵢ₋₁ is “127”, wherein the legend “B” denotes the operation in which the source line is placed in the high impedance state. When the grayscale level of the image data D₂ᵢ₋₁ is “127”, the most significant bit of the image data D₂ᵢ₋₁ is “0” and the source line to be driven to the positive drive voltage selected from the source lines 5₂ᵢ₋₁ and 5₂ᵢ is placed into the high impedance state.

The lower left section of FIG. 6A illustrates the voltage waveform of the source line driven to a positive drive voltage in the k-th horizontal sync period for the case when the grayscale level of the image data D₂ᵢ₋₁ is “128”, wherein the legend “C” denotes the operation in which the source line is precharged. When the grayscale level of the image data D₂ᵢ₋₁ is “128”, the most significant bit of the image data D₂ᵢ₋₁ is “1” and the source line to be driven to the positive drive voltage selected from the source lines 5₂ᵢ₋₁ and 5₂ᵢ is precharged to the voltage VCI.

Meanwhile, the control circuit 36₂ᵢ turns off the precharge switch 35₂ᵢ when the most significant bit of the image data D₂ᵢ is “0” and turns on the precharge switch 35₂ᵢ when the most significant bit of the image data D₂ᵢ is “1”. This results in that, as illustrated in FIG. 6B, the source line to be driven to a negative drive voltage selected from the source lines 5₂ᵢ₋₁ and 5₂ᵢ is placed into the high impedance state when the most significant bit of the image data D₂ᵢ is “0” and precharged to the voltage VCL when the most significant bit of the image data D₂ᵢ is “1.”

The upper left section of FIG. 6B illustrates the voltage waveform of the source line driven to a negative drive voltage in the k-th horizontal sync period for the case when the grayscale level of the image data D₂ᵢ is “127.” In this case, the most significant bit of the image data D₂ᵢ is “0” and the source line to be driven to the negative drive voltage selected from the source lines 5₂ᵢ₋₁ and 5₂ᵢ is placed into the high impedance state.

The lower left section of FIG. 6B illustrates the voltage waveform of the source line driven to a negative drive voltage in the k-th horizontal sync period for the case when the grayscale level of the image data D₂ᵢ₋₁ is “128.” In this case, the most significant bit of the image data D₂ᵢ is “1” and the source line to be driven to the negative drive voltage selected from the source lines 5₂ᵢ₋₁ and 5₂ᵢ is precharged to the voltage VCL.

In the drive period, which follows the precharge period, the source lines are driven to the voltages corresponding to the grayscale levels indicated by the image data. In detail, the source line to be driven to a positive drive voltage selected from the source lines 5₂ᵢ₋₁ and 5₂ᵢ is driven to the voltage corresponding to the grayscale voltage V₂ᵢ₋₁ (typically, the same voltage as the grayscale voltage V₂ᵢ₋₁) by the output circuit 31₂ᵢ₋₁, as illustrated in FIG. 6A, and the source line to be driven to a negative drive voltage selected from the source lines 5₂ᵢ₋₁ and 5₂ᵢ is driven to the voltage corresponding to the grayscale voltage V₂ᵢ (typically, the same voltage as the grayscale voltage V₂ᵢ) by the output circuit 31₂ᵢ, as illustrated in FIG. 6B. In FIG. 6A, the positive voltage corresponding to the grayscale level of “127” is denoted by the legend “V_{P127}” and the positive voltage corresponding to the grayscale level of “128” is denoted by the legend “V_{P128}.” In FIG. 6B, the negative voltage corresponding to the grayscale level of “127” is denoted by the legend “V_{N127}” and the negative voltage corresponding to the grayscale level of “128” is denoted by the legend “V_{N128}.” The drive operation is thus completed in the k-th horizontal sync period.

### (2) Low Temperature Drive Operation

The right columns of FIGS. 6A and 6B are timing charts illustrating the operation of the liquid crystal display device 1 in the k-th horizontal sync period in embodiment #1 in the case that the low temperature drive operation is performed.

In embodiment #1, the precharge operation is unconditionally omitted independently of the grayscale levels indicated by the image data in the low temperature drive operation. Unconditionally omitting the precharge operation independently of the grayscale levels indicated by the image data effectively resolves the above-described problem that the actually-perceived brightness of a pixel largely varies at the grayscale level at which execution/non-execution of the precharge operation is switched.

More specifically, when the low temperature drive operation is performed, the precharge control signal S_{PRC}_{_}_{CTRL} is negated by the control section 13. The control circuits 36₂ᵢ₋₁ and 36₂ᵢ turn off the precharge switches 35₂ᵢ₋₁ and 35₂ᵢ in response to the negation of the precharge control signal S_{PRC}_{_}_{CTRL}.

In the low temperature drive operation, a high-impedance period is provided between the equalization period and the drive period in place of the precharge period. In the high-impedance period, the source lines are set to the high-impedance state. More specifically, in the high-impedance period, the precharge switches 35₂ᵢ₋₁ and 35₂ᵢ are turned off independently of the grayscale levels indicated by the image data, and the outputs of the output circuits 31₂ᵢ₋₁ and 31₂ᵢ are placed into the high-impedance state. This results in that the source lines 5₂ᵢ₋₁ and 5₂ᵢ are placed into the high-impedance state. In the right columns of FIGS. 6A and 6B, the legends “B” denote the operation in which the source lines are placed into the high-impedance state. When the source lines 5₂ᵢ₋₁ and 5₂ᵢ are set to the high-impedance state, the voltages on the source lines 5₂ᵢ₋₁ and 5₂ᵢ are basically kept unchanged.

The operations in the equalization period and the drive period in the low temperature drive operation are respectively the same as those in the normal drive operation. In the drive period, which follows the high-impedance period, the source lines are driven to the voltages corresponding to the grayscale levels indicated by the image data, to complete the drive operation in the k-th horizontal sync period.

As described above, the precharge operation is unconditionally omitted independently of the grayscale levels indicated by the image data in embodiment #1, when the low temperature drive operation is performed. This effectively resolves the problem that the actually-perceived brightness of a pixel largely varies at the grayscale level at which execution/non-execution of the precharge operation is switched.

### Embodiment #2

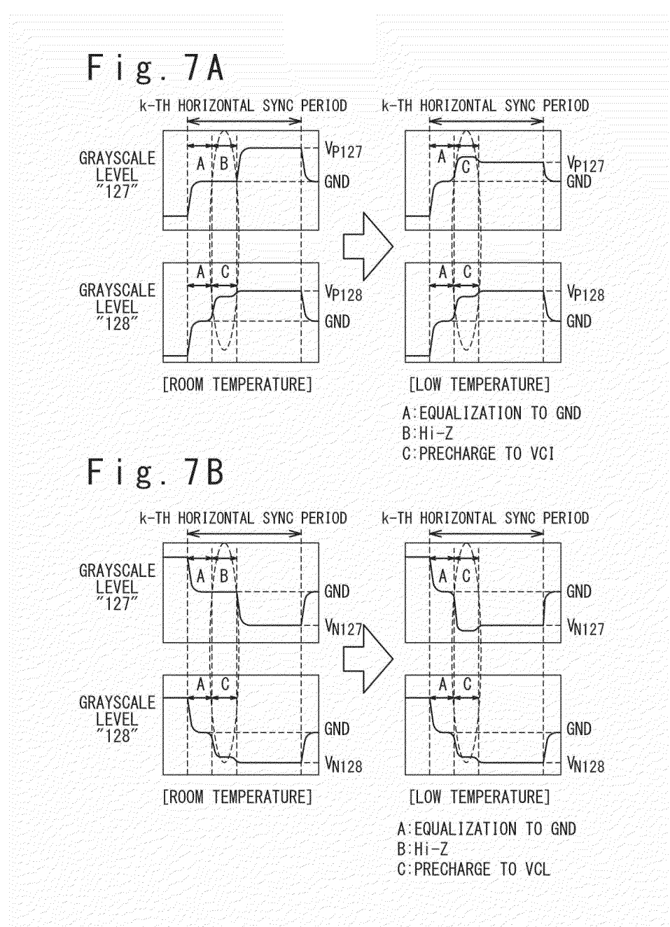

FIGS. 7A and 7B are timing charts illustrating one example of the drive operation of the source lines in the k-th horizontal sync period in embodiment #2. Note that FIG. 7A illustrates an exemplary operation in the case that a source line which has been driven to a negative voltage in the immediately previous horizontal sync period ((k−1)-th horizontal sync period) is driven to a positive voltage in the k-th horizontal sync period, and FIG. 7B illustrates an exemplary operation in the case that a source line which has been driven to a positive voltage in the immediately previous horizontal sync period ((k−1)-th horizontal sync period) is driven to a negative voltage in the k-th horizontal sync period.

Also in embodiment #2, the selection between the normal drive operation and the low temperature drive operation in response to the measured temperature by the temperature sensor 21 is performed in the same way as embodiment #1. Furthermore, the drive operation of the liquid crystal display panel 2 in the normal drive operation in embodiment #2 is the same as that in embodiment #1.

There exists, however, a difference between embodiments 1 and 2 in that the precharge operation is unconditionally performed independently of the grayscale levels indicated by the image data in the low temperature drive operation in embodiment #2. The right columns of FIGS. 7A and 7B illustrates the low temperature drive operation in embodiment #2. Unconditionally performing the precharge operation independently of the grayscale levels indicated by the image data also effectively resolves the above-described problem that the actually-perceived brightness of a pixel largely varies at the grayscale level at which execution/non-execution of the precharge operation is switched.

In the following, a detailed description is given of the low temperature drive operation in embodiment #2. The precharge control signal S_{PRC}_{_}_{CTRL} is asserted by the control section 13 when the low temperature drive operation is performed. The control circuits 36₂ᵢ₋₁ and 36₂ᵢ turn on the precharge switches 35₂ᵢ₋₁ and 35₂ᵢ in the precharge period in response to the assertion of the precharge control signal S_{PRC}_{_}_{CTRL}.

When the low temperature drive operation is performed in the k-th horizontal sync period, three periods are defined in the k-th horizontal sync period: an equalization period, a precharge period and a drive period. The precharge period is defined to follow the equalization period and the drive period is defined to follow the precharge period.

In the equalization period, equalization of the source lines is performed. More specifically, the equalizing switches 34₂ᵢ₋₁ and 34₂ᵢ are turned on to connect the nodes N₂ᵢ₋₁ and N₂ᵢ to the circuit ground line 37, and the outputs of the output circuits 31₂ᵢ₋₁ and 31₂ᵢ are placed into the high impedance (Hi-Z) state. This results in that the source lines 5₂ᵢ₋₁ and 5₂ᵢ are electrically connected to the circuit ground line 37, and thereby equalized to the circuit ground level. In FIGS. 7A and 7B, the legends “A” denote the operation in which the source lines are equalized to the circuit ground level GND.

In the precharge period, which follows the equalization period, the precharge operation is unconditionally performed independently of the grayscale levels indicated by the image data. More specifically, the operation descried below is performed in the precharge period.

In response to the assertion of the precharge control signal S_{PRC}_{_}_{CTRL} the control circuits 36₂ᵢ₋₁ and 36₂ᵢ turn on the precharge switches 35₂ᵢ₋₁ and 35₂ᵢ. This results in that, as illustrated in the right column of FIG. 7A, the source line to be driven to a positive drive voltage selected from the source lines 5₂ᵢ₋₁ and 5₂ᵢ is precharged to the voltage VCI, and as illustrated in the right column of FIG. 7B, the source line to be driven to a negative drive voltage selected from the source lines 5₂ᵢ₋₁ and 5₂ᵢ is precharged to the voltage VCL.

In the drive period, which follows the precharge period, the source lines are driven to the voltages corresponding to the grayscale levels indicated by the image data. In detail, the source line to be driven to the positive drive voltage selected from the source lines 5₂ᵢ₋₁ and 5₂ᵢ is driven to the voltage corresponding to the grayscale voltage V₂ᵢ₋₁ (typically, the same voltage as the grayscale voltage V₂ᵢ₋₁) by the output circuit 31₂ᵢ₋₁, as illustrated in FIG. 7A, and the source line to be driven to the negative drive voltage selected from the source lines 5₂ᵢ₋₁ and 5₂ᵢ is driven to the voltage corresponding to the grayscale voltage V₂ᵢ (typically, the same voltage as the grayscale voltage V₂ᵢ) by the output circuit 31₂ᵢ, as illustrated in FIG. 7B. The drive operation is thus completed in the k-th horizontal sync period.

As described above, in embodiment #2, the precharge operation is unconditionally performed independently of the grayscale levels indicated by the image data when the low temperature drive operation is performed. This effectively resolves the problem that the actually-perceived brightness of a pixel largely varies at the grayscale level at which execution/non-execution of the precharge operation is switched.

### Embodiment #3

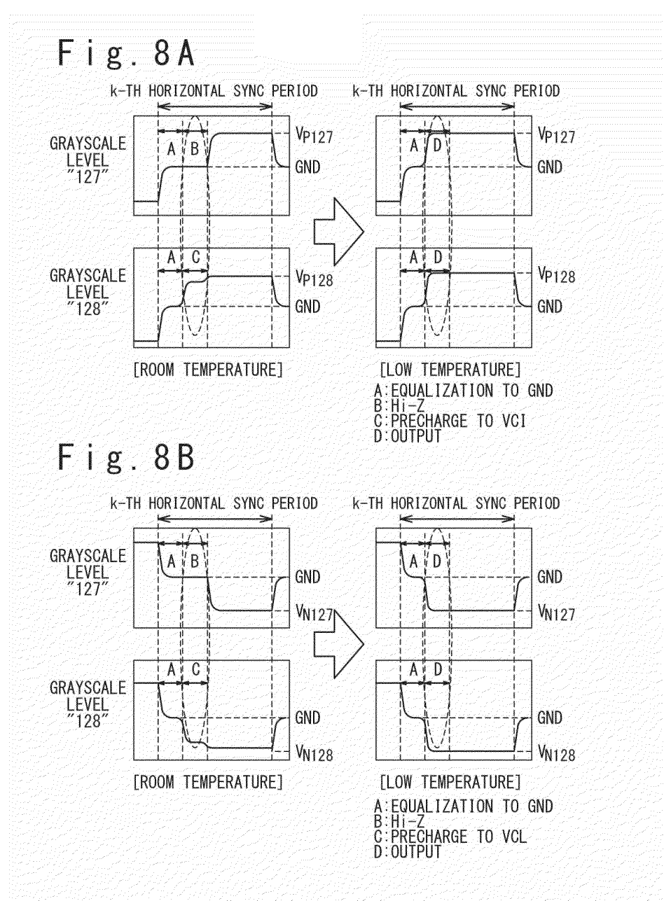

FIGS. 8A and 8B are timing charts illustrating one example of the drive operation of the source lines in the k-th horizontal sync period in embodiment #3. Note that FIG. 8A illustrates an exemplary operation in the case that a source line which has been driven to a negative voltage in the immediately previous horizontal sync period ((k−1)-th horizontal sync period) is driven to a positive voltage in the k-th horizontal sync period, and FIG. 8B illustrates an exemplary operation in the case that a source line which has been driven to a positive voltage in the immediately previous horizontal sync period ((k−1)-th horizontal sync period) is driven to a negative voltage in the k-th horizontal sync period.

Also in embodiment #3, the selection between the normal drive operation and the low temperature drive operation in response to the measured temperature by the temperature sensor 21 is performed in the same way as embodiment #1. Furthermore, the drive operation of the liquid crystal display panel 2 in the normal drive operation in embodiment #3 is the same as that in embodiment #1.

In embodiment #3, as is the case with embodiment #1, the precharge operation is unconditionally omitted independently of the grayscale levels indicated by the image data in the low temperature drive operation. It should be noted however that the high-impedance period is not provided in embodiment #3. Instead, a precedent output operation which involves precedently outputting the voltages corresponding to the grayscale levels indicated by the image data is performed in the period corresponding to the precharge period of the normal drive operation. The period in which the precedent output operation is performed is referred to as the precedent output period, hereinafter. In FIGS. 8A and 8B, the legends “D” denote the precedent drive operation. The operation of embodiment #3 also effectively resolves the above-described problem that the actually-perceived brightness of a pixel largely varies at the grayscale level at which execution/non-execution of the precharge operation is switched. Additionally, the operation of embodiment #3 lengthens the time duration during which the source lines are kept to the voltages corresponding to the grayscale levels indicated by the image data when the liquid crystal display device 1 is operated at low temperature; this effectively makes the actually-perceived brightness of each pixel of the liquid crystal display panel 2 close to the desired brightness, even if the response speed of the liquid crystal display panel 2 is decreased at low temperature.

In the following, a description is given of the low temperature drive operation in embodiment #3. When the low temperature drive operation is performed, the precharge control signal S_{PRC}_{_}_{CTRL} is negated by the control section 13. The control circuits 36₂ᵢ₋₁ and 36₂ᵢ turn off the precharge switches 35₂ᵢ₋₁ and 35₂ᵢ in response to the negation of the precharge control signal S_{PRC}_{_}_{CTRL}.

When the low temperature drive operation is performed in the k-th horizontal sync period, three periods are defined in the k-th horizontal sync period: an equalization period, a precedent output period and a drive period. The precedent output period is defined to follow the equalization period and the drive period is defined to follow the precedent output period. The precedent output period is defined as a period corresponding to the precharge period in the normal drive operation.

In the equalization period, equalization of the source lines is performed. More specifically, the equalizing switches 34₂ᵢ₋₁ and 34₂ᵢ are turned on to connect the nodes N₂ᵢ₋₁ and N₂ᵢ to the circuit ground line 37, and the outputs of the output circuits 31₂ᵢ₋₁ and 31₂ᵢ are placed into the high impedance (Hi-Z) state. This results in that the source lines 5₂ᵢ₋₁ and 5₂ᵢ are electrically connected to the circuit ground line 37, and thereby equalized to the circuit ground level. In FIGS. 8A and 8B, the legends “A” denote the operation in which the source lines are equalized to the circuit ground level GND.

In the precedent output period, which follows the equalization period, the source lines are driven to the voltages corresponding to the grayscale levels indicated by the image data. In detail, the source line to be driven to a positive drive voltage selected from the source lines 5₂ᵢ₋₁ and 5₂ᵢ is driven to the voltage corresponding to the grayscale voltage V₂ᵢ₋₁ (typically, the same voltage as the grayscale voltage V₂ᵢ₋₁) by the output circuit 31₂ᵢ₋₁, as illustrated in FIG. 8A, and the source line to be driven to a negative drive voltage selected from the source lines 5₂ᵢ₋₁ and 5₂ᵢ is driven to the voltage corresponding to the grayscale voltage V₂ᵢ (typically, the same voltage as the grayscale voltage V₂ᵢ) by the output circuit 31₂ᵢ, as illustrated in FIG. 8B.

In the drive period, the operation in which the source lines are driven to the voltages corresponding to the grayscale levels indicated by the image data is continued. The respective source lines are kept to the voltages corresponding to the grayscale levels indicated by the associated image data. The drive operation is thus completed in the k-th horizontal sync period.

In embodiment #3, as described above, the precharge operation is unconditionally omitted independently of the grayscale levels indicated by the image data in the low temperature drive operation. This effectively resolves the problem that the actually-perceived brightness of a pixel largely varies at the grayscale level at which execution/non-execution of the precharge operation is switched.

Additionally, the operation in embodiment #3 effectively addresses the reduction in the response speed of the liquid crystal display panel 2 at the low temperature, since the low temperature drive operation involves precedently outputting the voltages corresponding to the grayscale levels indicated by the image data in the period corresponding to the precharge period defined in the normal drive operation.

### Embodiment #4

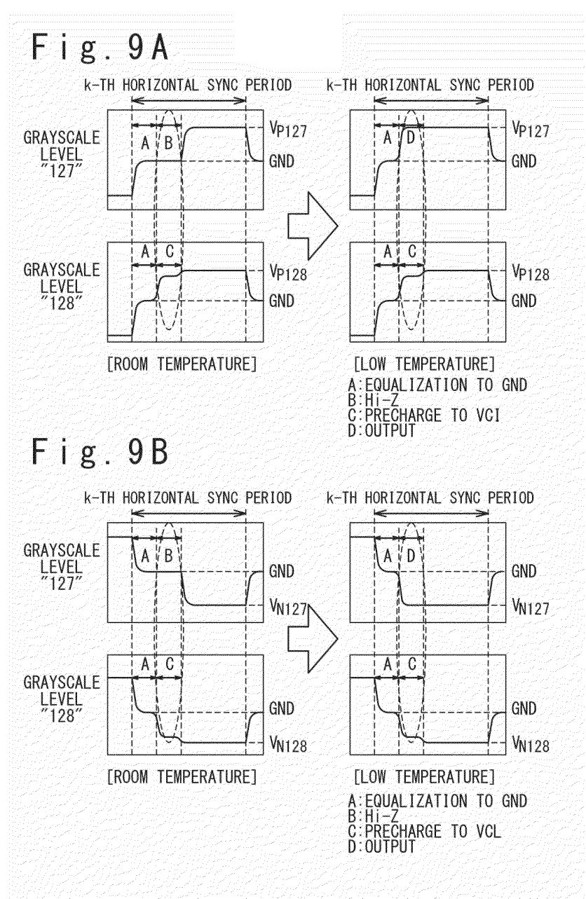

FIGS. 9A and 9B are timing charts illustrating one example of the source line drive operation in the k-th horizontal sync period in embodiment #4. Note that FIG. 9A illustrates an exemplary operation in the case that a source line which has been driven to a negative voltage in the immediately previous horizontal sync period ((k−1)-th horizontal sync period) is driven to a positive voltage in the k-th horizontal sync period, and FIG. 9B illustrates an exemplary operation in the case that a source line which has been driven to a positive voltage in the immediately previous horizontal sync period ((k−1)-th horizontal sync period) is driven to a negative voltage in the k-th horizontal sync period.

Also in embodiment #4, the selection between the normal drive operation and the low temperature drive operation in response to the measured temperature by the temperature sensor 21 is performed in the same way as embodiment #1. Furthermore, the drive operation of the liquid crystal display panel 2 in the normal drive operation in embodiment #4 is the same as that in embodiment #1.

In embodiment #4, one of the precharge operation and the precedent output operation is selectively preformed for each source line in response to the grayscale level indicated by the corresponding image data in the low temperature drive operation. As described above, the precedent output operation involves precedently outputting the voltages corresponding to the grayscale levels indicated by the image data. In FIGS. 9A and 9B, the legends “D” denote the precedent drive operation. At the grayscale level at which execution/non-execution of the precharge operation is switched, the voltage waveform on a source line in the case that the precharge operation is performed is not the same but similar to the voltage waveform on the source line in the case that the precedent output operation is performed. Accordingly, the above-described operation in embodiment #4 also effectively resolves the above-described problem that the actually-perceived brightness of a pixel largely varies at the grayscale level at which execution/non-execution of the precharge operation is switched.

In the following, a description is given of the low temperature drive operation in embodiment #4.

In embodiment #4, the precharge control signal S_{PRC}_{_}_{CTRL} is asserted by the control section 13 also when the low temperature drive operation is performed. When the precharge control signal S_{PRC}_{_}_{CTRL} is asserted, the control circuit 36₂ᵢ₋₁ is placed into the state in which the control circuit 36₂ᵢ₋₁ controls the precharge switch 35₂ᵢ₋₁ in response to the most significant bit D_{MSB(2i-1)} of the image data D₂ᵢ₋₁, and the control circuit 36₂ᵢ is placed into the state in which the control circuit 36₂ᵢ controls the precharge switch 35₂ᵢ in response to the most significant bit D_{MSB(2i)} of the image data D₂ᵢ.

When the low temperature drive operation is performed in the k-th horizontal sync period, three periods are defined in the k-th horizontal sync period: an equalization period, a precharge period and a drive period. The precharge period is defined to follow the equalization period and the drive period is defined to follow the precharge period.

In the equalization period, equalization of the source lines is performed. More specifically, the equalizing switches 34₂ᵢ₋₁ and 34₂ᵢ are turned on to connect the nodes N₂ᵢ₋₁ and N₂ᵢ to the circuit ground line 37, and the outputs of the output circuits 31₂ᵢ₋₁ and 31₂ᵢ are placed into the high impedance (Hi-Z) state. This results in that the source lines 5₂ᵢ₋₁ and 5₂ᵢ are electrically connected to the circuit ground line 37, and thereby equalized to the circuit ground level. In FIGS. 9A and 9B, the legends “A” denote the operation in which the source lines are equalized to the circuit ground level GND.

In the precharge period, which follows the equalization period, one of the precharge operation and the precedent output operation selected in response to the grayscale level indicated by the image data, more particularly, the most significant bit of the image data is performed. The following is a detailed description of the operation performed in the precharge period.

The control circuit 36₂ᵢ₋₁ turns off the precharge switch 35₂ᵢ₋₁ when the most significant bit of the image data D₂ᵢ₋₁ is “0”, whereas the control circuit 36₂ᵢ₋₁ turns on the precharge switch 35₂ᵢ₋₁ when the most significant bit of the image data D₂ᵢ₋₁ is “1.” The output circuit 31₂ᵢ₋₁ outputs the voltage corresponding to the grayscale voltage V₂ᵢ₋₁ (typically, the same voltage as the grayscale voltage V₂ᵢ₋₁) when the most significant bit of the image data D₂ᵢ₋₁ is “0”, whereas the output circuit 31₂ᵢ₋₁ sets the output thereof to the high-impedance state when the most significant bit of the image data D₂ᵢ₋₁ is “1.”

As illustrated in FIG. 9A, this results in that the source line to be driven to a positive drive voltage selected from the source lines 5₂ᵢ₋₁ and 5₂ᵢ is driven to the voltage corresponding to the grayscale level indicated by the image data D₂ᵢ₋₁ when the most significant bit of the image data D₂ᵢ₋₁ is “0”, and precharged to the voltage VCI when the most significant bit of the image data D₂ᵢ₋₁ is “1.”

The upper right section of FIG. 9A illustrates the voltage waveform on the source line driven to a positive drive voltage for the case that the grayscale level indicated by the image data D₂ᵢ₋₁ is “127.” The legend “D” in FIG. 9A denotes the precedent output operation. When the grayscale level indicated by the image data D₂ᵢ₋₁ is “127”, the most significant bit of the image data D₂ᵢ₋₁ is “0” and the source line to be driven to the positive drive voltage selected from the source lines 5₂ᵢ₋₁ and 5₂ᵢ is driven to the voltage V_{P127}, which corresponds to the grayscale level indicated by the image data D₂ᵢ₋₁.

The lower right section of FIG. 9A illustrates the voltage waveform on the source line driven to a positive drive voltage for the case that the grayscale level indicated by the image data D₂ᵢ₋₁ is “128.” The legend “C” in FIG. 9A denotes the precharge operation of the source line. When the grayscale level indicated by the image data D₂ᵢ₋₁ is “128”, the most significant bit of the image data D₂ᵢ₋₁ is “1” and the source line driven to the positive drive voltage selected from the source lines 5₂ᵢ₋₁ and 5₂ᵢ is precharged to the voltage VCI.

Meanwhile, the control circuit 36₂ᵢ turns off the precharge switch 35₂ᵢ when the most significant bit of the image data D₂ᵢ is “0”, whereas the control circuit 36₂ᵢ turns on the precharge switch 35₂ᵢ when the most significant bit of the image data D₂ᵢ is “1.” The output circuit 31₂ᵢ outputs the voltage corresponding to the grayscale voltage V₂ᵢ (typically, the same voltage as the grayscale voltage V₂ᵢ) when the most significant bit of the image data D₂ᵢ is “0”, whereas the output circuit 31₂ᵢ sets the output thereof to the high-impedance state when the most significant bit of the image data D₂ᵢ is “1.”

As illustrated in FIG. 9B, this results in that the source line to be driven to a negative drive voltage selected from the source lines 5₂ᵢ₋₁ and 5₂ᵢ is driven to the voltage corresponding to the grayscale level indicated by the image data D₂ᵢ when the most significant bit of the image data D₂ᵢ is “0”, and precharged to the voltage VCL when the most significant bit of the image data D₂ᵢ is “1.”

The upper right section of FIG. 9B illustrates the voltage waveform on the source line driven to a negative drive voltage for the case that the grayscale level indicated by the image data D₂ᵢ is “127.” When the grayscale level indicated by the image data D₂ᵢ is “127”, the most significant bit of the image data D₂ᵢ is “0” and the source line to be driven to the negative drive voltage selected from the source lines 5₂ᵢ₋₁ and 5₂ᵢ is driven to the voltage V_{N127}, which corresponds to the grayscale level indicated by the image data D₂ᵢ.

The lower right section of FIG. 9B illustrates the voltage waveform on the source line driven to a negative drive voltage for the case that the grayscale level indicated by the image data D₂ᵢ is “128.” In this case, the most significant bit of the image data D₂ᵢ is “1” and the source line driven to the negative drive voltage selected from the source lines 5₂ᵢ₋₁ and 5₂ᵢ is precharged to the voltage VCL.

In the drive period, which follows the precharge period, the source lines are driven to the voltages corresponding to the grayscale levels indicated by the image data. In detail, the source line to be driven to the positive drive voltage selected from the source lines 5₂ᵢ₋₁ and 5₂ᵢ is driven to the voltage corresponding to the grayscale voltage V₂ᵢ₋₁ (typically, the same voltage as the grayscale voltage V₂ᵢ₋₁) by the output circuit 31₂ᵢ₋₁, as illustrated in FIG. 9A, and the source line to be driven to the negative drive voltage selected from the source lines 5₂ᵢ₋₁ and 5₂ᵢ is driven to the voltage corresponding to the grayscale voltage V₂ᵢ (typically, the same voltage as the grayscale voltage V₂ᵢ) by the output circuit 31₂ᵢ, as illustrated in FIG. 9B. The drive operation is thus completed in the k-th horizontal sync period.

As described above, in the low temperature drive operation in embodiment #4, a selected one of the precharge operation and the precedent output operation is performed in response to the grayscale level indicated by the image data, more particularly, to the most significant bit of the image data. This effectively relieves the problem that the actually-perceived brightness of a pixel largely varies at the grayscale level at which execution/non-execution of the precharge operation is switched.

Although the configuration in which the temperature sensor 21 is integrated in the display driver 3 is depicted in the above-described embodiments, a person skilled would understand that the temperature sensor 21 may be provided at any desired position in the liquid crystal display device 1. In one embodiment, the temperature sensor 21 may be coupled with the liquid crystal display panel 2. Also in this case, execution/non-execution of the precharge operation is selected in response to the measured temperature by the temperature sensor 21.

Although specific embodiments of the present invention have been described above, the present invention should not be construed as being limited to the above-described embodiments; it would be apparent to a person skilled in the art that the present invention may be implemented with various modifications.

What is claimed is:

1. A driver adapted to drive a source line of a liquid crystal display panel, comprising:
a temperature sensor;
a drive circuitry configured to drive the source line to a voltage corresponding to a grayscale level indicated by image data; and
a precharge circuitry configured to perform a precharge operation of the source line,
wherein, when a measured temperature by the temperature sensor is in a first temperature range, the precharge circuitry selectively performs the precharge operation of the source line in response to the grayscale level indicated by the image data,
wherein, when the measured temperature is in a second temperature range lower than the first temperature range, the precharge circuitry performs one of first and second operations,
wherein the first operation includes unconditionally performing the precharge operation of the source line independently of the grayscale level indicated by the image data, and
wherein the second operation includes unconditionally omitting the precharge operation of the source line independently of the grayscale level indicated by the image data.

2. The driver according to claim 1, wherein, when the measured temperature is in the second temperature range, the precharge circuitry is configured to never perform the precharge operation of the source line.

3. The driver according to claim 1, wherein, when the measured temperature is in the second temperature range, the precharge circuitry always performs the precharge operation of the source line.

4. The driver according to claim 2, further comprising an equalization circuitry configured to perform an equalization operation in which the source line is electrically connected to another source line of the liquid crystal display panel,
wherein, when the measured temperature is in the first temperature range, the equalization circuitry is configured to perform the equalization operation in a first period of each horizontal sync period, the precharge circuitry is configured to perform the precharge operation of the source line in response to the grayscale level indicated by the image data in a second period of each horizontal sync period, the second period following the first period, and the drive circuitry is configured to drive the source line to the voltage corresponding to the grayscale level indicated by the image data in a third period of each horizontal sync period, the third period following the second period, and
wherein, when the measured temperature is in the second temperature range, the equalization circuitry is configured to perform the equalization operation in the first period of each horizontal sync period, and the drive circuitry is configured to drive the source line to the voltage corresponding to the grayscale level indicated by the image data in the second and third periods of each horizontal sync period.

5. The driver according to claim 1, wherein, when the measured temperature is in the first temperature range, the precharge circuitry is configured to perform the precharge operation of the source line in response to a most significant bit of the image data, and
wherein, when the measured temperature is in the second temperature range, the precharge circuitry is configured to perform one of the first and second operations independently of the most significant bit of the image data.

6. A driver adapted to drive a source line of a liquid crystal display panel, comprising:
a temperature sensor;
a drive circuitry configured to drive the source line in response to image data;
a precharge circuitry configured to perform a precharge operation of the source line; and
an equalization circuitry configured to perform an equalization operation in which the source line is electrically connected to another source line of the liquid crystal display panel,
wherein, when the measured temperature is in a first temperature range, the equalization circuitry is configured to perform the equalization operation in a first period of each horizontal sync period, the precharge circuitry is configured to perform the precharge operation of the source line in response to the grayscale level indicated by the image data in a second period of each horizontal sync period, the second period following the first period, and the drive circuitry is configured to drive the source line to the voltage corresponding to the grayscale level indicated by the image data in a third period of each horizontal sync period, the third period following the second period,
wherein, when the measured temperature is in a second temperature range lower than the first temperature range, the equalization circuitry is configured to perform the equalization operation in the first period of each horizontal sync period, wherein one of first and second operations selected in response to the grayscale level indicated by the image data is performed in the second period of each horizontal sync period, and the drive circuitry is configured to drive the source line to the voltage corresponding to the grayscale level indicated by the image data in the third period of each horizontal sync period,
wherein, in the first operation, the precharge circuitry performs the precharge operation of the source line, and
wherein, in the second operation, the drive circuitry drives the source line to the voltage corresponding to the grayscale level indicated by the image data.

7. The driver according to claim 6, wherein, when the measured temperature is in the second temperature range, selection of the first and second operations is responsive to the most significant bit of the image data.

8. A liquid crystal display device, comprising:
a liquid crystal display panel including a source line;
a driver; and
a temperature sensor,
wherein the driver includes:
drive circuitry configured to drive the source line to a voltage corresponding to a grayscale level indicated by image data; and
precharge circuitry configured to perform a precharge operation of the source line,
wherein, when a measured temperature by the temperature sensor is in a first temperature range, the precharge circuitry performs the precharge operation of the source line in response to the grayscale level indicated by the image data,
wherein, when the measured temperature is in a second temperature range lower than the first temperature range, the precharge circuitry performs one of first and second operations,
wherein the first operation includes unconditionally performing the precharge operation of the source line independently of the grayscale level indicated by the image data, and
the second operation includes unconditionally omitting the precharge operation of the source line independently of the grayscale level indicated by the image data.

9. The liquid crystal display device according to claim 8, wherein, when the measured temperature is in the second temperature range, the precharge circuitry is configured to never perform the precharge operation of the source line.

10. The liquid crystal display device according to claim 8, wherein, when the measured temperature is in the second temperature range, the precharge circuitry is configured to always perform the precharge operation of the source line.

11. The liquid crystal display device according to claim 9,
wherein the driver further includes an equalization circuitry configured to perform an equalization operation in which the source line is electrically connected to another source line of the liquid crystal display panel,
wherein, when the measured temperature is in the first temperature range, the equalization circuitry is configured to perform the equalization operation in a first period of each horizontal sync period, the precharge circuitry is configured to perform the precharge operation of the source line in response to the grayscale level indicated by the image data in a second period of each horizontal sync period, the second period following the first period, and the drive circuitry is configured to drive the source line to the voltage corresponding to the grayscale level indicated by the image data in a third period of each horizontal sync period, the third period following the second period, and
wherein, when the measured temperature is in the second temperature range, the equalization circuitry is configured to perform the equalization operation in the first period of each horizontal sync period, and the drive circuitry is configured to drive the source line to the voltage corresponding to the grayscale level indicated by the image data in the second and third periods of each horizontal sync period.

12. A liquid crystal display device, comprising:
a liquid crystal display panel including a source line;
a driver; and
a temperature sensor,
wherein the driver includes:
drive circuitry configured to drive the source line to a voltage corresponding to a grayscale level indicated by image data;
precharge circuitry configured to perform a precharge operation of the source line; and
equalization circuitry configured to perform an equalization operation in which the source line is electrically connected to another source line of the liquid crystal display panel,
wherein, when the measured temperature is in a first temperature range, the equalization circuitry is configured to perform the equalization operation in a first period of each horizontal sync period, the precharge circuitry is configured to perform the precharge operation of the source line in response to the grayscale level indicated by the image data in a second period of each horizontal sync period, the second period following the first period, and the drive circuitry is configured to drive the source line to the voltage corresponding to the grayscale level indicated by the image data in a third period of each horizontal sync period, the third period following the second period,
wherein, when the measured temperature is in a second temperature range lower than the first temperature range, the equalization circuitry is configured to perform the equalization operation in the first period of each horizontal sync period, wherein one of first and second operations selected in response to the grayscale level indicated by the image data is performed in the second period of each horizontal sync period, and the drive circuitry is configured to drive the source line to the voltage corresponding to the grayscale level indicated by the image data in the third period of each horizontal sync period,
wherein, in the first operation, the precharge circuitry is configured to perform the precharge operation, and
wherein, in the second operation, the drive circuitry is configured to drive the source line to the voltage corresponding to the grayscale level indicated by the image data.

13. A method for driving a liquid crystal display panel of a liquid crystal display device including a temperature sensor, the method comprising:
performing a precharge operation of a source line of the liquid crystal display panel in response to a measured temperature by the temperature sensor; and
driving the source line to a voltage corresponding to a grayscale level indicated by image data,
wherein the step of performing the precharge operation includes:
performing the precharge operation of the source line in response to the grayscale level indicated by the image data when the measured temperature is in a first temperature range; and
performing a selected one of first and second operations when the measured temperature is in a second temperature range lower than the first temperature range,
wherein the first operation includes unconditionally performing the precharge operation of the source line independently of the grayscale level indicated by the image data, and
wherein the second operation includes unconditionally omitting the precharge operation of the source line independently of the grayscale level indicated by the image data.

14. A method for driving a liquid crystal display panel of a liquid crystal display device including a temperature sensor, the method comprising:
performing an equalization operation in which the source line is electrically connected to another source line of the liquid crystal display panel, in a first period of each horizontal sync period;
selectively performing one of first and second operations in response to a measured temperature by the temperature sensor in a second period of each horizontal sync period, the second period following the first period; and
driving the source line to the voltage corresponding to the grayscale level indicated by the image data in a third period of each horizontal sync period, the third period following the second period,
wherein the first operation includes performing a precharge operation of the source line by the precharge circuitry in response to the grayscale level indicated by the image data,
wherein the second operation includes driving the source line to the voltage corresponding to the grayscale level indicated by the image data by the drive circuitry,
wherein, when the measured temperature is in a first temperature range, the precharge operation of the source line is performed in response to the grayscale level indicated by the image data when the measured temperature in the second period of each horizontal sync period, and
wherein, when the measured temperature is in a second temperature range lower than the first temperature range, one of the first and second operations selected in response to the grayscale level indicated by the image data is performed in the second period of each horizontal sync period.
